(19) United States
(12) Patent Application Publication
(10) Pub. No.: US 2007/0228005 A1
(43) Pub. Date: Oct. 4, 2007

(54) Erasable Ink, Method of Erasing Image Including the Same, and Method of Recycling Recording Medium Using the Erasing Method

(75) Inventors: Waka Hasegawa, Kanagawa-ken (JP); Yuichi Hashimoto, Tokyo (JP); Naotoshi Miyamachi, Tokyo (JP); Ryosuke Fudou, Kanagawa-ken (JP); Naoko Tsuyoshi, Kanagawa-ken (JP); Tadashi Asano, Tokyo (JP)

Correspondence Address: FITZPATRICK CELLA HARPER & SCINTO, 30 ROCKEFELLER PLAZA, NEW YORK, NY, 10112, US

(73) Assignees: Canon Kabushiki Kaisha, Tokyo (JP); Ajinomoto Co., Inc., Tokyo (JP); Space Environmental Technology Co., Ltd., Tokyo (JP)

(21) Appl. No.: 11/574,709

(22) PCT Filed: Sep. 7, 2005
(86) PCT No.: PCT/JP05/16877

§ 371 Date: Mar. 5, 2007

(30) Foreign Application Priority Data
Sep. 10, 2004 (JP) 2004-264385

(51) Int. Cl. C09D 11/00; B41J 2/01; C09B 23/00; C09B 61/00

(52) U.S. Cl. 216/58; 106/31.32

(57) ABSTRACT

The invention provides a method for easily and promptly erasing an image (including a character) formed on a printed article with a low cost, and an apparatus employing such method. A printed article bearing an image formed on a surface including an inorganic pigment is exposed to a reactive gas generated by creeping discharge or corona discharge induced by a voltage applied between a pair of opposed electrodes, whereby the image is erased.

### TECHNICAL FIELD

The present invention relates to: an erasable ink containing a dye that can be produced by a microorganism; a method of erasing an image including the dye of a printed product obtained by means of the ink; and a method of recycling a recording medium using the erasing method.

### BACKGROUND ART

Along with the spreading of computers, printers, copying machines, facsimiles etc., requirement for output on paper is more and more increasing. No other media have ever become comparable to paper in visibility and portability, and realizing “electronic information society” or “paperless society” has not shown a progress as expected.

For this reason, technical development for recycling and reuse of paper is becoming increasingly important. In a prior paper recycling method, a recovered paper is repulped with water, then subjected to floating removal of an ink portion by a deinking process, further bleached and used as “recycled paper”. However such method has drawbacks that the paper strength is lowered and that a process cost is higher in comparison with a case of new papermaking. Consequently there is desired a method capable of reusing or recycling paper without a deinking process.

Based on such background, investigations are being made for a method of printing paper with an image forming material including an erasable dye composition capable of changing a color-forming compound in a colored state to an erased state. As such image forming material, Japanese Patent Application Laid-Open No. S63-39377 proposes a method of utilizing a reversible change in transparency of a recording layer under a control of applied thermal energy. Also Japanese Patent Application Laid-Open Nos. S61-237684, H05-124360, and 2001-105741 each propose a method of utilizing an intermolecular interaction between a color-forming agent having an electron donating property and a color developing agent having an electron accepting property. Also Japanese Patent Application Laid-Open No. H11-116864 proposes an ink including a dye of which color is erasable by an electron beam irradiation, and Japanese Patent Application Laid-Open No. 2001-49157 proposes an ink containing an additive having a function of erasing the color of a coloring agent by light irradiation. International Publication No. 02/088265 proposes an ink jet ink and a recording method utilizing a monascus yellow dye to be erasable by light irradiation.

On the other hand, Japanese Patent Application Laid-Open No. H07-253736 proposes a method of decomposing and erasing an image on ordinary paper with an activated gas.

### DISCLOSURE OF THE INVENTION

However the methods described in Japanese Patent Application Laid-Open Nos. S63-39377, S61-237684, H05-124360, and 2001-105741 are impractical since the recording medium, writing-erasing apparatus etc. are expensive in the initial cost and in the running cost. Also, the method described in Japanese Patent Application Laid-Open No. H11-116864, employing electron beam irradiation, may cause the deterioration of a base material or generation of a secondary X-ray, even though slightly. Also in the method described in Japanese Patent Application Laid-Open No. 2001-49157, the additive to be employed is more specifically a dye-based sensitizer and is employed in a large amount of 1/10 to 10/10 in weight ratio with respect to the coloring agent, thus resulting a high cost of the ink. Also investigations are being made for methods capable of erasing an image easier and faster than the methods described in International Publication No. 02/088265 and Japanese Patent Application Laid-Open No. H07-253736.

Therefore, an object of the present invention is to provide an erasable ink for forming an image (including a character) as a printed article that can be erased easily, promptly, and with a low cost, and a method of erasing an image formed by means of the ink.

Another object of the present invention is to provide a method of recycling a recording medium having an image formed by means of the erasable ink as a blank recording medium, from which the image has been erased, with a low cost.

As a result of intensive investigations based on the aforementioned objectives, the inventors of the present invention have found that, for a printed article bearing an image with an erasable ink on a recording medium having an inorganic pigment-based coating layer on a base material, such image can be erased easily, promptly, and with a low cost by exposure to an oxidizing gas. Furthermore, the inventors have searched for an erasable ink suitable for the method to find the erasable ink of the present invention, and have thus made the present invention. In the present invention, an “erasure of image” means not only a case where the image recorded on the recording medium becomes visually not at all recognizable (hereinafter called “color erasing”) but also a case where an initial image is thinned to a predetermined optical density (for example the optical density of the image being decreased to 80% of that of an original image) (hereinafter called “color density decreasing”).

That is, the present invention includes at least the following contents.

According to one aspect of the present invention, there is provided an erasable ink containing: a solvent; and at least one selected from the group consisting of a violet dye that can be produced by a Penicillium fungus, a yellow dye that can be produced by a Monascus fungus, and a compound represented by the following general formula (I) or (II), wherein a color of the erased ink is erased by creeping discharge or corona discharge.

According to another aspect of the present invention, there is provided a method of erasing an image of a printed article formed on a surface, which contains an inorganic pigment, of a recording medium, the image being formed on the surface by means of ink containing at least one selected from the group consisting of a violet dye that can be produced by a Penicillium fungus, a yellow dye that can be produced by a Monascus fungus, and a compound represented by the following general formula (I) or (II), the method comprising the steps of:

(i) applying a voltage between a first electrode and a second electrode separated by a dielectric member having a surface for creeping discharge in an atmosphere of a gas capable of generating an oxidizing gas through discharge to generate creeping discharge from a surface for creeping discharge, to thereby generate an oxidizing gas from the gas; and (ii) exposing the image of the printed article to the oxidizing gas.

According to further another aspect of the present invention, there is provided a method of erasing an image of a printed article formed on a surface, which contains an inorganic pigment, of a recording medium, the image being formed on the surface by means of ink containing at least one selected from the group consisting of a violet dye that can be produced by a Penicillium fungus, a yellow dye that can be produced by a Monascus fungus, and a compound represented by the following general formula (I) or (II), the method comprising the steps of:

(a) applying a voltage which is negative with respect to a grounded first electrode to a second electrode in an atmosphere of a gas capable of generating an oxidizing gas through discharge to generate corona discharge between the electrodes, to thereby generate an oxidizing gas; and

(b) exposing the image of the printed article to the oxidizing gas.

According to another aspect of the present invention, there is provided a method of recycling a recording medium having, on its surface which contains an inorganic pigment, an image of a printed article formed by means of ink containing at least one selected from the group consisting of a violet dye that can be produced by a Penicillium fungus, a yellow dye that can be produced by a Monascus fungus, and a compound represented by the following general formula (I) or (II), the method including the step of erasing the image by means of the above-described erasing method. 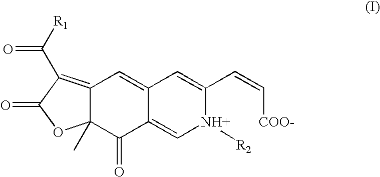
(In the formula, R₁ represents an alkyl group having 2 to 10 carbon atoms, and R₂ represents a hydrogen atom or a group that can be a side chain of a primary amine). 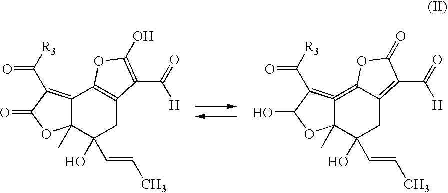
(In the formula, R₃ represents an alkyl group having 2 to 10 carbon atoms).

According to the present invention, there is provided an erasable ink the color of which is erasable by creeping discharge or corona discharge, the erasable ink containing at least one dye selected from a violet dye that can be produced by a Penicillium fungus, a yellow dye that can be produced by a Monascus fungus, and the following general formula (I) or (II). In addition, an image formed on a surface, which contains an inorganic pigment, of a recording medium, the image containing at least one selected from the group consisting of a violet dye that can be produced by a Penicillium fungus, a yellow dye that can be produced by a Monascus fungus, and a compound represented by the following general formula (I) or (II), can be erased by exposing a printed article having the image to an oxidizing gas generated by creeping discharge or corona discharge. As a result, a deinking step can be dispensed and an apparatus for erasing can be made compact. It is therefore possible to achieve the color erasing or color density decreasing of an image easily and promptly, with a low cost.

### BRIEF DESCRIPTION OF THE DRAWINGS

FIG. 1 is a schematic lateral view showing an example of an erasing apparatus of the present invention.

FIG. 2 is a schematic lateral view showing another example of an erasing apparatus of the present invention.

FIG. 3 is a schematic lateral view showing still another example of an erasing apparatus of the present invention.

FIG. 4 is a schematic lateral view showing still another example of an erasing apparatus of the present invention.

FIG. 5 is a schematic lateral view showing still another example of an erasing apparatus of the present invention.

FIG. 6 is a schematic lateral view showing still another example of an erasing apparatus of the present invention.

FIG. 7 is a schematic lateral view showing still another example of an erasing apparatus of the present invention.

FIG. 8 is a schematic lateral view showing still another example of an erasing apparatus of the present invention.

FIG. 9 is a schematic lateral view showing still another example of an erasing apparatus of the present invention.

### BEST MODE FOR CARRYING OUT THE INVENTION

Hereinafter, the present invention will be described in detail.

[1] Coloring Material

(1) Dye

The dye to be incorporated into the erasable ink according to the present invention the color of which is erasable by creeping discharge or corona discharge (which may hereinafter be simply referred to as “discharge”) contains at least one kind of a violet dye and a yellow dye the color of each of which is erasable by discharge. That is, each of ones selected from a violet dye and a yellow dye derived from specific microorganisms, and a compound represented by of the following general formula (I) or (II) may be used singly, or two or more of them may be used as a mixture. Those dyes, which can be produced by specific microorganisms, may be synthetic products or semisynthetic products, may be isolated and purified, and may be mixtures containing other components without any particular limitation as long as they can be used for ink. An example of a red dye the color of which is erasable by discharge includes a Monascus dye typified by monascoruburin described in International Publication No. 02/088265. In the present invention, at least one selected from the group consisting of a violet dye that can be produced by a Penicillium fungus, a yellow dye that can be produced by a Monascus fungus, and a compound represented by the following general formula (I) or (II) can be used. The ink of the present invention may be added with any other dye the color of which is erasable by discharge to such an extent that the objects and effects of the present invention are not impaired. Alternatively, the ink of the present invention may be combined with ink containing any other dye the color of which is erasable by discharge to form an image. Hereinafter, a violet dye that can be produced by a Penicillium fungus and a yellow dye that can be produced by a Monascus fungus will be described in detail.

(a) Violet Dye that can be Produced by Penicillium Fungus

Examples of the dye that can be produced by a Penicillium fungus include griseofulvum (produced by P. griseofulvum) and emodin (produced by P. islandicum). The violet dye according to the present invention the color of which is erasable by discharge is preferably an azaphilone-based compound. The term “azaphilone-based compound” is a generic name for a compound having an isochromene skeleton or an isoquinoline skeleton, and an analogue thereof (see Journal of Bioscience and Bioengineering, vol. 90, No. 5, p. 549-554 (2000) and Angew. Chem. Int. Ed. Vol. 43, P. 1239-1243 (2004)), and, in the present invention, refers to a violet dye or a blue dye having a maximum absorption wavelength in a solution state of 550 nm to 700 nm. Of those, one represented by the following general formula (I) is preferable. In the present invention, the violet dye that can be produced by a Penicillium fungus may be produced by any microorganism as long as the dye has a structure represented by the following general formula (I). In addition, the dye may be a synthetic product or a semisynthetic product. Furthermore, the term is used for a violet dye or a blue dye having a structure similar to the above structure the color of which is erasable by discharge treatment.

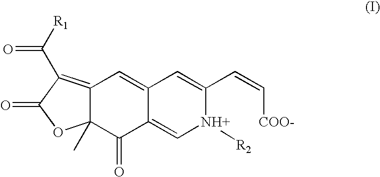

In the formula, R₁ represents an alkyl group having 2 to 10 carbon atoms, preferably an alkyl group having 5 to 7 carbon atoms, or particularly preferably C₇H₁₅ or C₅H₁₁. R₂ is not particularly limited as long as it represents a hydrogen atom or a group that can be a side chain of a primary amine. However, in terms of availability and the like, R₂ represents a hydrogen atom, an alkyl group, a substituted alkyl group, or the like. Examples of the alkyl group include, but not limited to, a methyl group, an ethyl group, a propyl group, a butyl group, and a pentyl group. Examples of the substituted alkyl group include, but not limited to, substituted alkyl groups derived from amino acids such as a 1-carbonylmethyl group and a 1-carbonylethyl group.

Since the compound is produced by an exchange reaction with a primary amine according to the following reaction formula, any group that can be a side chain of a primary amine capable of mediating the following reaction can be the side chain of R₂ in the formula (I). Examples of the primary amine to be used at this time include ammonia, an amino acid, a peptide, a nucleic acid, and a protein. Of those, ammonia or an amino acid is preferable.

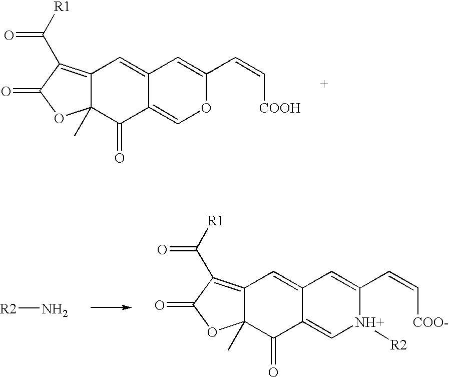

A lactone ring of the compound (I) may be opened in the presence of water or alcohol. The dye of the present invention also includes the ring-opening type.

An azaphilone-based compound is mainly produced by the cultivation of a microorganism, and a representative example thereof includes a Monascus dye that can be produced by a Monascus fungus. Any other microorganism than a Monascus fungus has been known to produce the azaphilone-based compound. The dye represented by the following structural formula (III) is a violet dye (PP-V) found by Hagiwara et al. which is produced by a Penicillium fungus (Journal of Bioscience and Bioengineering, vol. 90, No. 5, p. 549-554 (2000)). The compound is extremely similar in structure to monascorubramine out of the Monascus dyes.

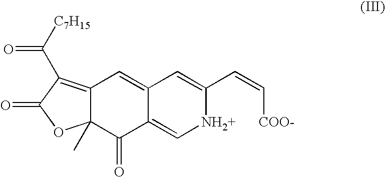

Any Penicillium fungi can be used for producing the dye of the present invention as long as it is a strain having an ability to produce a blue dye or a violet dye the color of which is erasable by discharge. Examples thereof include Penicillium purpurogenum (such as a catalogue No. NBRC 6022 in National Institute of Technology and Evaluation, Biological Resource Center (NBRC)), and modifications and mutants thereof.

The azaphilone-based compound may be extracted with an organic solvent from the culture, or may be obtained by concentrating and drying a supernatant fraction of the culture broth. An extracting solvent can be, for example, n-propyl alcohol, methanol, ethanol, butanol, acetone, ethyl acetate, dioxane or chloroform. The extract can be purified by an ordinary isolating method such as silica gel chromatography or reversed phase liquid chromatography to isolate an azaphilone-based compound of a desired purity. The dye thus obtained contains a violet dye (PP-V).

(b) Monascus Yellow Dye

The term “monascus yellow dye” as used herein refers to a Xanthomonasin compound produced by a Monascus fungus. The compound can be obtained by: drying a culture broth of a Monascus pulverizing the dried product; extracting the pulverized product with ethanol which is weakly hydrochloric acid-acidified at a gently warmed condition; and neutralizing the extract. The Xanthomonasin as a main dye is represented by the following general formula (II). The compound represented by the general formula (II) is referred to as Xanthomonasin A when R₃ represents C₅H₁₁, or is referred to as Xanthomonasin B when R₃ represents C₇H₁₅. More specifically, Monasco Yellow (trade name: manufactured by Kiriya Chemical Co., Ltd.), Highmoon Yellow S (trade name: manufactured by YAEGAKI Bio-industry, Inc.), and the like are commercially available. In the present invention, the monascus yellow dye may be a synthetic product or a semisynthetic product in addition to one produced by a microorganism. Furthermore, the term is used for a yellow dye having a structure similar to that represented by the following general formula (II) the color of which is erasable by discharge treatment.

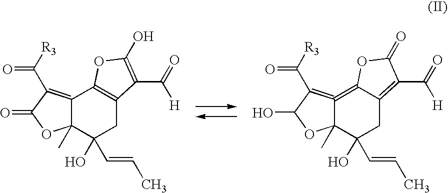

In the formula, R₃ represents an alkyl group having 2 to 10 carbon atoms, preferably an alkyl group having 5 to 7 carbon atoms, or particularly preferably C₇H₁₅ or C₅H₁₁. The compound is in an equilibrium state in an aqueous solution. Any form is included in the dye of the present invention.

(c) Method of Culturing Microorganism Capable of Producing Dye the Color of which is Erasable by Discharge

A method of culturing a microorganism capable of producing a dye the color of which is erasable by discharge is not particularly limited, and each of a solid culture method involving the use of a solid medium and a liquid culture method involving the use of a liquid medium can be used. The medium may be a conventionally known one containing a carbon source, a nitrogen source, mineral salts, and micronutrient. For example, a medium is used, which appropriately contains, as the carbon source, a saccharide such as soluble starch, glucose, or sucrose, and, as the nitrogen source, mineral salts, and micronutrient, a salt such as a nitrate or an ammonium salt, and a yeast extract.

The microorganism is inoculated to such medium, and the whole is aerobically cultured at a temperature of 20 to 40° C. for 2 to 14 days. There is no particular need to control a pH when submerged culture is performed.

As described above, the production of a dye produced by a microorganism can be easily managed as compared to an extracted dye extracted from an animal/plant or the like out of the natural dyes. Therefore, the dye produced by a microorganism can be stably produced in a large amount.

[2] Ink for Ink Jet

An image in the present invention is formed on the aforementioned recording medium for example by an ink jet recording method utilizing an ink jet ink containing the aforementioned various coloring agents. Such ink jet ink can be prepared by dissolving and/or dispersing the aforementioned various coloring agents in water or an organic solvent.

(1) Solvent

An organic solvent can be known one ordinarily employed in an ink jet ink. Specific examples thereof include an alcohol, a glycol, a glycol ether, a fatty acid ester, a ketone, an ether, a hydrocarbon solvent and a polar solvent. One kind selected from them may be used, or two or more selected from them may be used in combination. Water may be added in case the organic solvent is water-soluble. A water content in such case is preferably within a range of 30 to 95 weight % with respect to the total weight of the ink.

As the organic solvent, an alcohol or a glycol is preferable. Examples of alcohol include methanol, ethanol, 1-propanol, 2-propanol, 1-butanol, 2-butanol, isobutyl alcohol, and t-butyl alcohol.

Examples of glycol include ethylene glycol, diethylene glycol, triethylene glycol, polyethylene glycol, propylene glycol, dipropylene glycol, polypropylene glycol, butylene glycol, hexanediol, pentanediol, glycerin, hexanetriol, and thiodiglycol.

These organic solvent may be employed singly or in a suitable combination of two or more kinds. For example, there can be employed a combination of an alcohol and/or a glycol and a polar solvent. Examples of the polar solvent include 2-pyrrolidone, formamide, N,N-dimethylformamide, N,N-dimethylacetamide, dimethyl sulfoxide, sulforan, N-methyl-2-pyrrolidone, N-vinyl-2-pyrrolidone, 2-oxazolidone, 1,3-dimethyl-2-imidazolidinone, acetonitrile, and acetone.

The aforementioned dye may be dissolved in water or in an organic solvent, or may be pulverized with various dispersing equipment (such as a ball mill, a sand mill, an attriter, a roll mill, an agitator mill, a Henshell mixer, a colloid mill, an ultrasonic homogenizer, a pearl mill, a jet mill or an ong mill) according to the necessity and dispersed with a suitable dispersant (surfactant). The surfactant can be cationic, anionic, amphoteric, or nonionic.

The ink jet ink may further contain, if necessary, a binder, a pH regulating agent, a viscosity regulating agent, a penetrating agent, a surface tension regulating agent, an antioxidant, an antiseptic, an antimold agent etc.

The content of the dye is preferably 0.01 to 90 weight % with respect to the entire weight of the color erasable ink (composition), and more preferably 0.5 to 15 weight %. In this manner there can be obtained satisfactory printing property.

Also a print on the recording medium with the aforementioned ink can be made by an ink jet printing method or by a method utilizing a writing utensil of a pen shape or the like.

[3] Image Erasing Method and Apparatus

The method of erasing an image containing at least one selected from the group consisting of a violet dye that can be produced by a Penicillium fungus, a yellow dye that can be produced by a Monascus fungus, and a compound represented by the following general formula (I) or (II) (which may hereinafter be simply referred to as the “image”) according to the present invention includes the step of exposing, to an oxidizing gas, a printed article having an image on a surface, which contains an inorganic pigment, of a recording medium.

Such gas is preferably an ionized/dissociated gas or a secondary product thereof. Such secondary product is preferably at least one selected from the group consisting of ozone, hydroxy radical, carbonate ion, and a nitrogen oxide.

Such oxidizing gas is generated by creeping discharge or corona discharge.

In the following, each oxidizing gas generating means will be explained in detail, with reference to accompanying drawings. A gas capable of generating an oxidizing gas through discharge can be, for example, air, oxygen, nitrogen, carbon dioxide, or water vapor. If necessary, two or more kinds of those gases may be used in combination.

In the following there will be explained a case of employing air as an example.

(1) Creeping Discharge

In case of creeping discharge, discharge is generated along a dielectric member by applying an AC voltage between a pair of electrodes separated by the dielectric member, thereby generating an oxidizing gas. A color-erasing/color-density-decreasing method in such case is preferably executed by placing a printed article or causing the printed article to run in or in the vicinity of a discharge area of the creeping discharge. Also for causing the printed article to run, it is preferable to employ at least a conveying means selected from the group consisting of an endless belt conveying, a roll conveying, and a drum conveying. The run may be run in a certain direction, reciprocating run, or a combination of them.

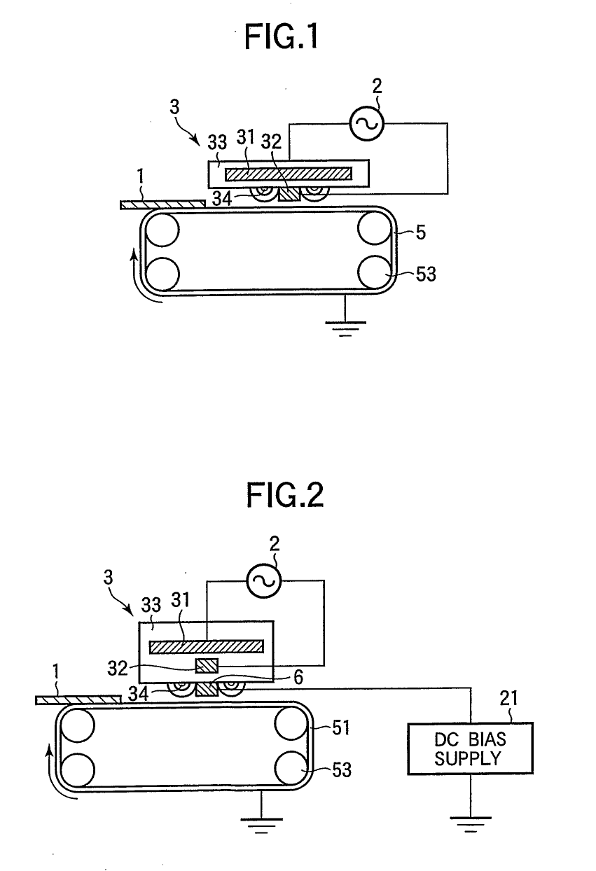

FIG. 1 is a schematic lateral view showing an example of an apparatus of the present invention for erasing an image of a printed article, for example obtained by forming an image (including a character) on a recording medium by an ink jet recording (such being hereinafter called a “printed article” unless specified otherwise). FIG. 1 shows an example of generating an oxidizing gas by applying an AC voltage to creeping discharge electrodes.

The oxidizing gas generated by creeping discharge in the air is an ionized/dissociated gas or a secondary product thereof, for example ozone, a carbonate ion, a nitrogen oxide etc. A similar oxidizing gas is generated also with corona discharge to be explained later, but the creeping discharge improves an efficiency of generation of the oxidizing gas.

Referring to FIG. 1, an electrode 3 for the creeping discharge includes a pair of electrodes 31 and 32 mutually opposed and separated by a dielectric member 33. As shown in FIG. 1, an electrode 31 is embedded in the dielectric member 33, and the other electrode 32 is provided at a bottom face of the dielectric member 33. The oxidizing gas is generated in a discharge area 34, present in a vicinity of the electrode 32 provided at the bottom face of the dielectric member 33. In FIG. 1, there is also shown an AC power supply 2.

The electrodes 31 and 32 are not particularly restricted in shapes thereof, and it is possible, for example, to form an electrode 31 embedded in the dielectric member 33 in a plate shape and to form the electrode 32 under the bottom face of the dielectric member 33 in a wire shape. Each of the electrodes 31 and 32 may be constituted of a metal such as Al, Cr, Au, Ni, Ti, W, Te, Mo, Fe, Co, or Pt, or an alloy or an oxide thereof. The electrodes 31 and 32 preferably have a mutual distance of 1 μm or larger, and more preferably 3 to 200 μm. An AC voltage (Vpp) applied to the creeping discharge electrode 3 is preferably within a range of 1 to 20 kV, and preferably has a frequency of 100 Hz to 5 MHz, and it is particularly preferable to employ a Vpp of 1 to 10 kV with a frequency of 1 kHz to 2 MHz, since the image erasure can be executed more efficiently. In such case, it is preferred to select a distance between the electrode 32 and the printed article to be 100 mm or less (including a distance of 0 mm corresponding to a case where the printed article and the electrode are in a mutual contact).

The dielectric member 33 is formed by a material that can form a surface capable of generating creeping discharge. Examples of such material include ceramics and glass. Specific example of the ceramics and the glass constituting the dielectric member 33 include a metal oxide such as silica, magnesia or alumina, and a nitride such as silicon nitride or aluminum nitride.

In exposing a printed article 1 to the oxidizing gas, the printed article 1 may be maintained stationarily or moved relatively to the discharge area 34 according to the purpose. FIG. 1 shows an example in which the printed article 1 is conveyed by a conductive endless belt 5 rotated by a roll 53 in the vicinity of creeping discharge area 34. The conductive endless belt 5 is so positioned as to pass a vicinity or an interior of the discharge area 34, whereby the discharge area 34 spreads in a space between the conductive endless belt 5 and the electrode 3 to improve a contact efficiency between the printed article 1 and the oxidizing gas. For this purpose it is preferable to ground the conductive endless belt 5 as shown in FIG. 1 or to apply a positive or negative voltage thereto. A conveying speed depends on Vpp, a frequency, and a distance between the electrode 32 and the printed article 1, but is preferably 2000 cm/min or less for the aforementioned ranges of the Vpp, frequency, and distance, and particularly preferably 500 cm/min or less, so that the image erasure can be executed more efficiently.

Conveying means for conveying the printed article 1 is not particularly limited and can be constituted by known means. In addition to the conveying by an endless belt, there can also be employed, for example, a roll conveying or a drum conveying. The conveying means is preferably constituted of a conductive material as described above, but this is not restrictive and it may also be constituted of a non-conductive material. A conductive material constituting the conveying means can be the same as those described for the electrodes 31 and 32.

The exposure of the printed article 1 to the oxidizing gas may be executed in a closed system or an open system, according to the purpose. However, it is executed preferably in a closed system in order that the oxidizing gas does not leak but from the color-density-decreasing/color-erasing apparatus. The color-density-decreasing/color-erasing apparatus is preferably provided with an adsorption filter for preventing leakage of the oxidizing gas.

FIG. 2 is a schematic lateral view showing another embodiment of the apparatus for erasing an image formed on a recording medium through creeping discharge. A component or a part equivalent to that in FIG. 1 is represented by the same reference number. An electrode 3 for creeping discharge shown in FIG. 2 is an application of a configuration of a charging/charge-eliminating apparatus described in Japanese Patent Application Laid-Open No. S62-177882 to the apparatus of the present invention, and is an example in which a pair of mutually opposed electrodes 31 and 32 are embedded in a dielectric member 33. In this case, the oxidizing gas is generated in a portion corresponding to an end portion of an electrode 32 at a bottom face of the dielectric member 33 (a portion indicated as a discharge area 34 shown in FIG. 2).

In the example shown in FIG. 2, as described in Japanese Patent Application Laid-Open No. S62-177882, a first bias electrode 6 and a power supply 21 for supplying the first bias electrode 6 with a DC bias voltage are provided on the bottom face of the dielectric member 33. An application of the bias voltage between the first bias electrode 6 and a conductive endless belt 51 serving also as a second bias electrode causes the oxidizing gas to move from a generating position toward the printed article 1, thereby improving the contact efficiency between the printed article 1 and the oxidizing gas. The bias voltage is preferably selected as 0.2 to 4.0 kV. The first bias electrode 6 can be constituted of the same material as that for the electrodes 31 and 32.

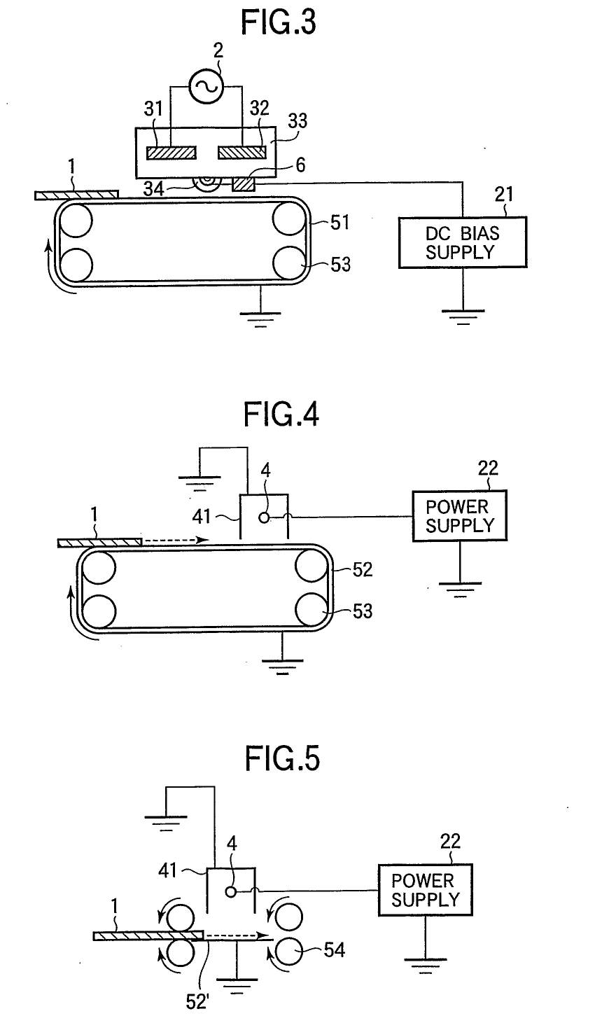

FIG. 3 is a schematic lateral view showing another embodiment of the apparatus for erasing an image by creeping discharge. A component or a part equivalent to that in FIG. 2 is represented by the same reference number. Creeping discharge electrode shown in FIG. 3 is also an application of the configuration of the charging/charge-eliminating apparatus described in Japanese Patent Application Laid-Open No. S62-177882 to the color-density-decreasing/color-erasing apparatus of the present invention, and is an example in which a pair of electrodes 31 and 32 are embedded so as to be arranged in a plane parallel to a bottom face of a dielectric member 33. In this case, the oxidizing gas is generated principally in the vicinity (a portion indicated as a discharge area 34 shown in FIG. 3) between electrodes 31 and 32 on the bottom face of the electric member. If necessary, there may also be adopted a configuration, in which, as described in Japanese Patent Application Laid-Open No. S62-177882, three electrodes are embedded so as to be arranged on a plane parallel to the bottom face of the dielectric member 33 (not shown).

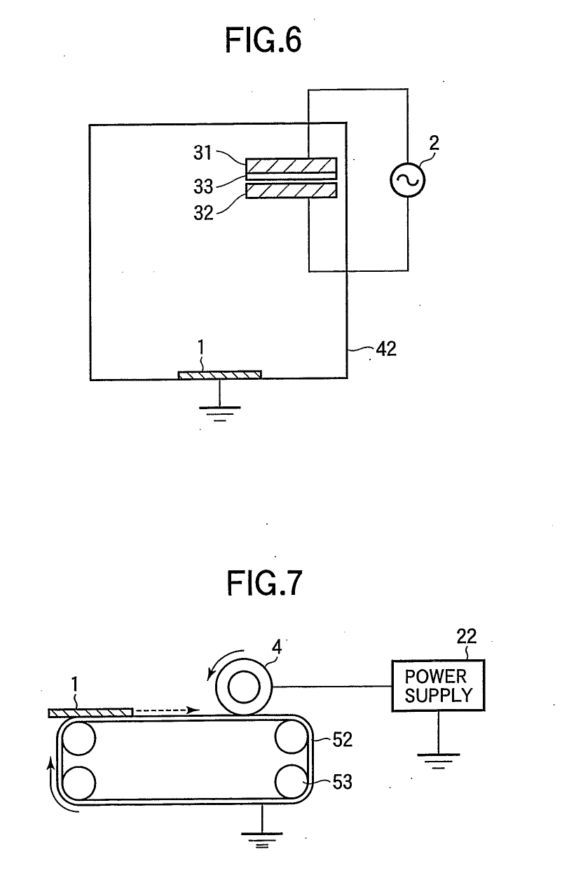

FIG. 6 is a schematic lateral view showing another embodiment of the apparatus for erasing an image by creeping discharge. A component or a part equivalent to that in FIG. 1 is represented by the same reference number. A dielectric layer 33 is provided on the electrodes 31 and/or 32. In the example shown in FIG. 6, both electrodes 31 and 32 are formed in a plate shape, and the dielectric member 33 is formed on the electrode 31. A printed article 1 is not positioned between the electrode 31 and the opposed electrode 32, but is placed stationarily in a closed container 42 covering the electrode 31, the dielectric member 33 and the plate-shaped counter electrode 32. The dielectric member 33 can be constituted of a material described for the case shown in FIG. 1 for utilizing the creeping discharge.

(2) Corona Discharge

In case of corona discharge, a voltage is applied between a discharge electrode and a counter electrode opposed to the discharge electrode to generate a discharge, thereby generating an oxidizing gas. The voltage applied to the discharge electrode can be an AC voltage or a DC voltage. In case of applying a DC voltage, a negative polarity is preferable. It is also possible to superpose an AC voltage with a DC voltage. The discharge is preferably generated in a state where the counter electrode is grounded. The discharge electrode can have a wire shape, a roll shape, a blade shape, a plate shape, a brush shape, a needle shape, or a bar shape. Also it is preferable to contact the counter electrode and the printed article in at least a part thereof. In the color-density-decreasing/color-erasing method for an image in such case, it is preferable to cause the printed article to remain stationary or to run in a discharge space between the discharge electrode and the counter electrode. Also in order to cause the printed article to run, there is preferably employed at least a conveying means selected from the group consisting of endless belt conveying, roll conveying, and drum conveying. It is further preferable that the conveying means have conductivity thereby serving also as the counter electrode. The run may be run in a certain direction, reciprocating run, or a combination of them.

FIG. 4 is a schematic lateral view showing an example of an apparatus of the present invention for erasing, by corona discharge, an image of a printed article in which an image (including a character) is formed on a recording medium for example by an ink jet recording. A component or a part equivalent to that in FIG. 1 is represented by the same reference number. In general, corona discharge is generated by providing a discharge electrode and a counter electrode in a position opposed thereto and applying a voltage to the discharge electrode. In the apparatus shown in FIG. 4, the discharge electrode 4 is formed in a wire shape, and a conductive endless belt 52 functions as a counter electrode. In order to efficiently generate an ionized/dissociated gas and a secondary product thereof by corona discharge, it is preferable, as shown in FIG. 4, to ground the conductive endless belt 52. In FIG. 4, there are also shown a DC voltage applying means 22 and a cover 41 covering the discharge electrode 4.

The applied voltage can be a DC voltage or a DC voltage superposed with an AC voltage. A particular satisfactory image erasure can be achieved in case of applying a DC voltage of a negative polarity to the discharge electrode 4. It is considered that the application of a DC voltage of a negative polarity to the discharge electrode 4 causes an efficient generation of an ionized/dissociated gas and a secondary product thereof, principally composed of an oxidizing gas, and that such gas composition is effective for reducing the color forming property of a dye contained for example an ink jet ink.

A material constituting the discharge electrode 4 and the counter electrode 52 can be selected from those described for the creeping discharge electrodes 31 and 32 in the foregoing (1) so as to match a shape or a structure of such electrodes. Electrodes shown in configurations shown in FIGS. 5 and 7 to 9 are also similarly constructed.

The corona discharge is initiated by an application of a voltage equal to or higher than a predetermined threshold voltage (discharge starting voltage). In the present invention, a DC voltage applied to the discharge electrode is preferably selected from −0.5 to −20.0 kV, particularly from −0.5 to −10.0 kV, and further preferably −0.1 kV, and a distance between the discharge electrode and the printed article is preferably selected as 30 mm or less (including 0 mm in case these are in mutual contact). In this manner it is possible to further efficiently erase the image of the printed article.

The shape of the discharge electrode 4 is not particularly restricted, and can have a known shape such as, in addition to a wire shape, a roll shape, a blade shape, a plate shape, a brush shape, a needle shape, or bar shape. Particularly in case of the corona discharge, a corona charger employing a wire shaped conductive material as the discharge electrode allows to obtain a uniform and high color-density-decreasing/color-erasing property to a dye over a wide area.

A printed article 1 is preferably in contact with the counter electrode 52, but need not necessarily be in contact. In case the printed article 1 is made present in a discharge area (area principally between the discharge electrode 4 and the counter electrode 52), the printed article 1 can be made stationary or made to run with respect to the discharge area according to the purpose. In case of an exposure to the oxidizing gas under a movement of the printed article, a moving speed of the printed article depends on a concentration of the oxidizing gas and a distance between the discharge electrode and the printed article, but is preferably 2000 cm/min or less for the aforementioned voltage and distance, and particularly preferably 500 cm/min or less, since the image erasure can be executed more efficiently.

As already explained on the creeping discharge in the foregoing (1), an exposure of the printed article 1 to the oxidizing gas may be executed in a closed system or an open system, according to the purpose, but it is executed preferably in a closed system. In case of a closed system, the printed article 1 may be placed stationarily outside the discharge area (area principally between the discharge electrode 4 and the counter electrode 52).

FIG. 5 is a schematic lateral view showing another example of the apparatus for erasing, by corona discharge, an image on a recording medium. A component or a part equivalent to that in FIG. 4 is represented by the same reference number. In the example shown in FIG. 5, the printed article 1 is conveyed on a conductive plate 52′ by rolls 54 and 54.

FIG. 7 is a schematic lateral view showing another example of the apparatus for erasing, by corona discharge, an image on a recording medium. A component or a part equivalent to that in FIG. 4 is represented by the same reference number. FIG. 7 shows an example provided with a roll-shaped discharge electrode 4. The roll-shaped discharge electrode 4 is in contact with a conductive endless belt 52 and is given a voltage while being rotated by the rotation of the conductive endless belt 52. The printed article 1 passes the discharge area in contact with both the roll-shaped discharge electrode 4 and the conductive endless belt 52, thus improving the contact efficiency with the oxidizing gas.

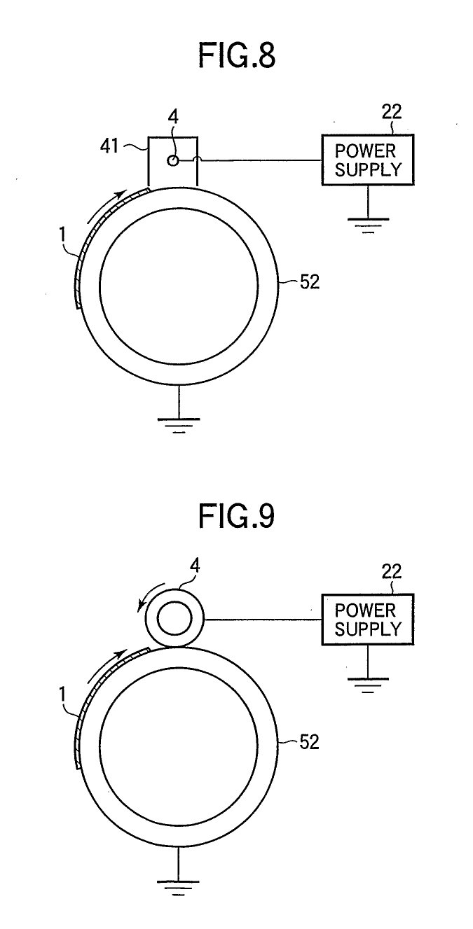

FIG. 8 is a schematic lateral view showing another example of the apparatus for erasing, by corona discharge, an image on a recording medium. A component or a part equivalent to that in FIG. 4 is represented by the same reference number. FIG. 8 shows an example of employing a conductive drum 52 as conveying means.

FIG. 9 is a schematic lateral view showing another example of the apparatus for color density decreasing or color erasing, by corona discharge, an image on a recording medium. A component or a part equivalent to that in FIG. 4 is represented by the same reference number. FIG. 9 shows an example of employing a roll-shaped discharge electrode 4 and a conductive drum 52.

The printed article of which image is erased by an action of a reactive gas generated by creeping discharge or corona discharge as in the apparatus shown in FIGS. 1 to 9 can be reused as a recording medium.

[4] Recording Medium Having an Inorganic Pigment on the Surface

In the image erasure of the present invention, an image is formed on a surface of a recording medium, having a surface including an inorganic pigment. In the present invention, therefore, there is advantageously employed a recording medium having a surface including an inorganic pigment, preferably a recording medium provided with a layer containing an inorganic pigment on a base material.

The inorganic pigment to be employed in the present invention is preferably a porous material, and can be at least one selected from the group consisting of alumina, silica, silica-alumina, colloidal silica, zeolite, clay, kaolin, talc, calcium carbonate, barium sulfate, aluminum hydroxide, titanium dioxide, zinc oxide, satin white, diatomaceous clay, and acidic white clay. Among these, it is preferable to use alumina or silica, more preferable alumina.

The base material employed in the present invention is not particularly restricted, can be any material such as a paper, a film, a photographic paper, a seal, a label, a compact disk, a metal, a glass, various plastic products, and a form for a delivery service, and can also be a composite material thereof. In case it is paper, there can be employed any recyclable paper without restriction, and an acidic paper, a neutral paper, or an alkaline paper may be employed. A base paper is principally constituted of a chemical pulp represented by LBKP or NBKP, and a filler, and papermaking is executed by an ordinary method utilizing an internal sizing agent or a papermaking additive etc. if necessary. A mechanical pulp or a recycled pulp may be used in combination as the pulp material to be used or may be used principally. A filler can be, for example, calcium carbonate, kaolin, talc, or titanium dioxide. The base paper may further contain or applied with a hydrophilic binder, a matting agent, a hardening agent, a surfactant, a polymer latex, a polymer mordanting agent, or the like. The base paper preferably has a basis weight of 40 to 700 g/m².

The base paper can be coated with an aqueous coating liquid prepared by adding an aqueous binder thereto. Such aqueous binder can be, for example, polyvinyl alcohol, casein, styrene-butadiene rubber, starch, polyacrylamide, polyvinylpyrrolidone, polyvinyl methyl ether, or polyethylene oxide. But these are not restrictive. Also these water-soluble polymers may be employed singly or in a combination of two or more kinds.

The mass ratio of the inorganic pigment and the aqueous binder (inorganic pigment/aqueous binder) is preferably 0.1 to 100, and more preferably 1 to 20. In case the weight ratio of the inorganic pigment and the aqueous binder (inorganic pigment/aqueous binder) exceeds 100, there tends to result falling of powder materials, and in case it is less than 0.1, it is difficult to obtain an enough color-erasing/color-density-decreasing property for the image.

The aqueous coating liquid is applied on the surface of the base paper for example by a roller coating, a blade coating, an air knife coating, a gate roll coating, a bar coating, a spray coating, a gravure coating, a curtain coating, or a comma coating. After the coating, drying is executed for example with a hot air drying oven or a heat drum to obtain a surface layer containing the inorganic pigment. In case of a heat drum, a dry finishing can be achieved by pressing the surface layer to a heated finishing surface. Also, the applied layer in a moist state before drying may be processed, in order to coagulate the aqueous binder, with an aqueous solution containing a nitrate salt, a sulfate salt, a formate salt, or an acetate salt of zinc, calcium, barium magnesium, or aluminum.

A coating amount in solid is preferably within a range of 0.1 to 50 g/m². In a coating amount less than 0.1 g/m², it is difficult to obtain a sufficient color-erasing/color-density-decreasing property for an ink jet print/image. On the other hand, a coating amount exceeding 50 g/m² scarcely provides an improvement in the print quality or in the color-erasing/color-density-decreasing property for the image. In the aqueous coating liquid, there may be suitably blended, if necessary, a pigment dispersant, a moisture retaining agent, a viscosifier, a defoaming agent, a releasing agent, a colorant, a water resistant agent, a moisturizing agent, a fluorescent dye, an ultraviolet absorber etc.

[5] Time Necessary for Color Erasure

Such image containing at least one selected from the group consisting of a violet dye that can be produced by a Penicillium fungus, a yellow dye that can be produced by a Monascus fungus, and a compound represented by and the general formula (I) or (II) as described above can fade (color density decrease) by exposure to an oxidizing gas, and can be finally erased to a visually unrecognizable level. Stated differently, by an exposure of a printed article to the oxidizing gas, the image becomes paler and eventually not observable. The image erasure is significantly influenced by a discharge voltage, but a time necessary for the color erasure is variable depending on a contact efficiency with the oxidizing gas, a composition of the oxidizing gas, a dye type, a dye concentration, a dye composition, a printing material etc. A color erasing time can be regulated by suitably selecting these conditions.

Also, the image erasing method of the present invention is applicable not only in a case of erasing an image of a printed article thereby reusing it as a recording medium, but also in case of utilizing a printed article, after the image erasure, as a raw material for producing a recycled paper.

### EXAMPLES

In the following, the present invention will be clarified in further details by examples, but the present invention is not limited to such examples.

### Recording Medium Preparation Example 1

Fine alumina powder (trade name: CATALOID AP-3, manufactured by Shokubai Kasei Kogyo Co.) and polyvinyl alcohol (trade name: SMR-10HH, manufactured by Shinetsu Chemical Co.) were mixed in a weight ratio of 90/10, and mixed with water under agitation so as to obtain a solid content concentration of 20 weight %. The mixture was applied on a PET film so as to obtain a weight of 30 g/m² after drying, and was dried for 10 minutes at 110° C. to obtain a recording medium 1.

### Recording Medium Preparation Example 2

In a 2-liter flask equipped with an agitator, 800 g of polyethylene glycol (average molecular weight 2000), 65 g of hexamethylene diisocyanate, 2 g of dibutyl tin laurate and 900 g of ethylene glycol dimethyl ether were charged, uniformly mixed by agitation for 30 minutes at the room temperature, then heated for 2 hours at 80° C. under agitation and cooled to obtain a highly viscous transparent liquid (binder A). The obtained liquid showed a viscosity of 30,000 mPa·s at 25° C., and the polymer contained in ethylene glycol dimethyl ether solvent had a number-average molecular weight of 85,000. Then a recording medium 2 was obtained in the same manner as the recording medium 1 except that polyvinyl alcohol was replaced by the binder A obtained in the aforementioned process.

### Recording Medium Preparation Example 3

In a 2-liter flask equipped with an agitator, 300 g of hydroxyethyl methacrylate, 350 g of water, 350 g of methanol and 1.5 g of azobisisobutyronitrile were charged, and agitated for 60 minutes at the room temperature. Then nitrogen gas was blown in to sufficiently replace the interior of the flask, the temperature was gradually raised under gradual nitrogen gas passing to 65° C. Then the mixture was polymerized for 3 hours in this state, and was cooled to obtain a highly viscous transparent liquid (binder B). The obtained liquid showed a viscosity of 1,800 mPa·s at 25° C., and the polymer contained in water/methanol mixed solvent had a number-average molecular weight of 150,000. Then a recording medium 3 was obtained in the same manner as the recording medium 1 except that polyvinyl alcohol was replaced by the binder B obtained in the aforementioned process.

### Recording Medium Preparation Example 4

Colloidal silica (trade name: SNOWTEX C, manufactured by Nissan Chemical Co.) and polyvinyl alcohol (trade name: SMR-10HH, manufactured by Shinetsu Chemical Co.) were mixed in a weight ratio of 90/10, and mixed with water under agitation so as to obtain a solid content concentration of 20 weight %. The mixture was applied on a PET film so as to obtain a weight of 30 g/m² after drying, and was dried for 10 minutes at 110° C. to obtain a recording medium 4.

### Ink Preparation Examples 1 to 5

Components shown in the following Table 1 were mixed, dissolved under sufficient agitation, and pressure filtered with a Fluoropore filter (trade name, manufactured by Sumitomo Denko Co.) of a pore size of 0.45 μm to obtain inks 1 to 5. Tetrasodium copper phthalocyanine tetrasulfonate was manufactured by Kishida Kagaku Co. A gardenia dye, a cayenne dye, and a chlorophyll were manufactured by Kiriya Chemical Co., Ltd. Also indigo carmine was manufactured by Nakarai Tesk Co.

TABLE 1

| | Ink 1 | Ink 2 | Ink 3 | Ink 4 | Ink 5 |
|---|---|---|---|---|---|
| Tetrasodium copper | 2.5 | | | | |
| phthalocyanine | | | | | |
| tetrasulfonate | | | | | |
| Gardenia yellow dye | | 2.5 | | | |
| Cayenne dye | | | 2.5 | | |
| Chlorophyll | | | | 2.5 | |
| Indigo carmine | | | | | 2.5 |
| Glycerin | 7.5 | 7.5 | 7.5 | 7.5 | 7.5 |
| Diethylene glycol | 7.5 | 7.5 | 7.5 | 7.5 | 7.5 |
| Acetylenol EH* | 0.1 | 0.1 | 0.1 | 0.1 | 0.1 |
| Water | 82.4 | 82.4 | 82.4 | 82.4 | 82.4 |

(unit: weight %)
*Acetylenol EH (trade name, manufactured by Kawaken Fine Chemical Co.): ethylene oxide addition product of acetylene alcohol (HLB = 14-15)

### Ink Preparation Example 6

In a 500-ml Sakaguchi flask, 100 ml of a yeast-malt (YM) culture medium (composed of 1 weight % of glucose, 0.3 weight % of yeast extract (manufactured by Difco Laboratories, Inc.), 0.3 weight % of malt extract (manufactured by Difco Laboratories, Inc.), 0.5 weight % of bactopeptone (manufactured by Difco Laboratories, Inc.), and water in the remainder) were charged, adjusted to a pH value of 6.5 and sterilized under a pressure for 20 minutes at 120° C. After cooling, Monascus purpureus (NBRC 4478) cultivated on a YM slant agar culture medium was inoculated by a sterile loop, and cultivated on a shaker for 2 days at 30° C. to obtain a seed culture. 5 ml of thus obtained seed culture were inoculated in 100 ml of a YM culture medium, sterilized as described above, and cultivated on a shaker for 3 days at 30° C. After the main cultivation, the culture broth was centrifuged (9,000 rpm, 10 min) to obtain a supernatant. The obtained supernatant showed an optical absorbance of 0.2 at a wavelength of 500 nm in 1/100 dilution in distilled water. The supernatant was added with ethanol of the same amount, mixed, and centrifuged (9,000 rpm, 10 min) to eliminate water-insoluble dyes. The obtained supernatant was concentrated to dry to obtain a water-soluble red dye. The dye was mixed with ethanol at a ratio of dye/ethanol=10.0/90.0, and then dissolved under sufficient agitation and filtered with a Fluoropore filter (trade name, manufactured by Sumitomo Denko Co.) of a pore size of 0.45 μm to obtain an ink 6.

### Culture Examples 1 to 4

In a 5-liter Sakaguchi flask, 1 liter of a YM culture medium same as in the ink production example 6 was charged, adjusted to a pH value of 6.5 and sterilized under a pressure for 20 minutes at 120° C. After cooling, Monascus purpureus (NBRC 4478) cultivated on a YM agar culture medium was inoculated by a sterile loop to the above mentioned medium, and cultivated on a shaker for 2 days at 30° C. to obtain a seed culture broth.

Separately, in a 1-liter glass jar, 450 ml of a YM culture medium same as above were charged, then sterilized under a pressure for 20 minutes at 120° C., and, after cooling, the seed bacterial liquid was inoculated by 10% (v/v). A shaking culture medium was conducted for 7 days at 30° C., maintaining the culture broth at pH 4.0, utilizing sulfuric acid in the culture example 1, phosphoric acid in the culture example 2, or acetic acid in the culture example 3, as a pH regulating agent. In the culture example 4, the pH value at the start was adjusted to 6.5, and cultivated without pH control. The production amount of monascorubrin in the culture broth obtained in the culture examples 1 to 4 was measured by HPLC. Conditions of HPLC analysis were taken from a method described in International Publication No. 02/088265. Obtained results are shown in Table 2.

TABLE 2

| | | | Monascorubrin |
|---|---|---|---|
| | pH regulating | Controlled | production |
| | agent | pH | amount (mg/L) |
| Culture example 1 | Sulfuric acid | 4.0 | 220.5 |
| Culture example 2 | Phosphoric acid | 4.0 | 259.6 |
| Culture example 3 | Acetic acid | 4.0 | 953.5 |
| Culture example 4 | None | None | 7.4 |

As shown in Table 2, the amount of monascorubrin was evidently increased by a culture under an acidic condition, and was further increased by employing acetic acid as the pH regulating agent, in comparison with a mineral acid such as sulfuric acid or phosphoric acid. Rubropunctatin and monascorubrin obtained by such culture method can be employed in an addition reaction with an amino compound thereby obtaining a water-soluble dye in a more efficient manner.

### Ink Preparation Example 7

The culture broth obtained in the culture example 3 was centrifuged (9,000 rpm, 10 min) to separate a supernatant liquid and fungal cells. The obtained dye-containing wet fungal cells were lyophilized to determine a water content, which was 75.6 weight %.

400 g of the obtained wet fungal cells were added with 10 liters of ethyl acetate, and mixed for 1 hour and filtered with a filter paper to separate a filtrate and fungal cells. The aqueous phase was removed from the filtrate to obtain an ethyl acetate layer. The obtained ethyl acetate extract was rinsed twice by adding water of the same amount. The ethyl acetate extract after rinsing was dried by concentration to obtain a red-orange colored dye containing monascorubrin and rubropunctatin.

10.8 g of the obtained red-orange dye were added with acetonitrile to obtain 2095 ml of an acetonitrile solution containing red-orange dye. An aqueous solution of monosodium glutamate (30 mg/ml) of the same amount was added thereto, and the mixture was reacted for 3 days at the room temperature under agitation, and was dried by concentration to obtain a water-soluble dye. The obtained dye was so mixed as to obtain a ratio of dye/glycerin/diethylene glycol/acetylenol EH (manufactured by Kawaken Fine Chemical Co., EO addition of acetylene glycol)/water=2.5/7.5/7.5/0.1/82.4 (weight ratio), then dissolved under sufficient agitation and was filtered with a Fluoropore filter (trade name, manufactured by Sumitomo Denko Co.) of a pore size of 0.45 μm to obtain an ink 7.

After the reaction for generating the water-soluble dye by the addition of monosodium glutamate, monascorubrin and rubropunctatin in the reaction liquid were analyzed by HPLC, but monascorubrin and rubropunctatin were not detected. Also on a liquid obtained by diluting the reaction liquid to 1/100, an absorbance at 500 nm was measured as 68.

### Culture Example 5

In a 500-ml Erlenmeyer flask, 100 ml of a medium for dye production (a medium composed of 2 weight % soluble starch, 0.2 weight % yeast extract (manufactured by Difco Laboratories, Inc.), 0.3 weight % ammonium nitrate, and a 50 mM citric acid buffer (pH5) in remainder) were charged, and sterilized under a pressure for 20 minutes at 120° C. After cooling, Penicillium purpurogenum (NBRC 6022) that had grown well on a potato dextrose agar culture medium (manufactured by Difco Laboratories, Inc.) was inoculated by a sterile loop to the above mentioned medium, and cultivated on a shaker for 5 days at 30° C. After the cultivation, the culture broth was centrifuged (9,000 rpm, 10 min) to obtain a supernatant. The supernatant liquid was dried by concentration, and the resultant was analyzed by means of thin-layer chromatography. A thin-layer plate used was an HPTLC plate silica gel 60 (manufactured by Merck), and a developing solution used was a mixture of butanol:acetic acid:water=12:3:5.

The thin-layer chromatography resulted in the detection of a violet spot having an Rf value of 0.72. The spot was scraped from the thin-layer plate, extracted with acetone, and analyzed by HPLC (column: CAPCELL PAK C18 UG120 (4.6×250 mm) (manufactured by Shiseido Co., Ltd.), eluent solution: 0.05% TFA: 0.05% TFA acetonitrile=45:55, flow rate: 1 ml/min, temperature: 40° C., detection 560 nm). The analysis resulted in the detection of a peak at an elution time of 8.7 min. After having been purified, the substance was subjected to visible-ultraviolet absorption spectral analysis, mass spectrometry (MS), and NMR measurement to identify the substance as a violet dye (PP-V) having the structure represented by the formula (III).

### Ink Preparation Example 8

Liquid shaking culture was performed in the same manner as in Culture example 5 for dye production. 2.6 L of a culture broth were centrifuged (9,000 rpm, 10 min) to obtain a supernatant. The pH of the supernatant liquid was adjusted to 3, and the supernatant liquid was added with ethyl acetate of the same amount, followed by extraction. An ethyl acetate layer was placed in another vessel and added with a saturated NaHCO₃ solution, and the whole was agitated. As a result, the ethyl acetate layer presented a violet color. This operation was repeated four times, and the resultant ethyl acetate layer was collectively dried by concentration to obtain about 120 mg of a crude violet dye (PP-V).

The dye was mixed with 50% methanol at a ratio of dye/50% methanol=1.4/98.6 (weight ratio), and then dissolved under sufficient agitation and filtered with a Fluoropore filter (trade name, manufactured by Sumitomo Denko Co.) of a pore size of 0.45 μm under a pressure to obtain an ink 8.

### Ink Preparation Example 9

A monascus yellow dye solution was mixed with diethylene glycol, glycerin, and water at a ratio of monascus yellow dye/diethylene glycol/glycerin/water=81.5/7.5/7.5/3.5 (weight ratio), and then dissolved under sufficient agitation and filtered with a Fluoropore filter (trade name, manufactured by Sumitomo Denko Co.) of a pore size of 0.45 μm under a pressure to obtain an ink 9. Monasco Yellow S (trade name: manufactured by Kiriya Chemical Co., Ltd.) was used as the monascus yellow dye solution.

### Printed Article Preparation Examples 1 to 12

The obtained inks 1 to 9 were used to conduct solid print with an on-demand type ink jet printer (trade name: Wonder BJ F-660, manufactured by Canon Corp.) utilizing a heat generating element as an ink discharging energy source on the recording media 1 to 4 to obtain printed articles 1 to 12. The contents of the printed articles are shown in Table 3.

TABLE 3

| | Recording | |
|---|---|---|
| | medium | Ink |
| Printed article 1 | 1 | 1 |
| Printed article 2 | 2 | 1 |
| Printed article 3 | 3 | 1 |
| Printed article 4 | 4 | 1 |
| Printed article 5 | 1 | 2 |
| Printed article 6 | 1 | 3 |
| Printed article 7 | 1 | 4 |
| Printed article 8 | 1 | 5 |
| Printed article 9 | 1 | 6 |
| Printed article 10 | 1 | 7 |
| Printed article 11 | 1 | 8 |
| Printed article 12 | 1 | 9 |

(Evaluation of Color-Erasing/Color-Density-Decreasing Property)

### Reference Examples 1 to 10

In an apparatus shown in FIG. 1 and explained in the foregoing item [3] (1) (dielectric member: alumina ceramics, electrode embedded in the dielectric member: chromium, electrode provided on the bottom face of the dielectric member: chromium), under the application of an AC voltage of a frequency of 5 kHz, and an applied voltage Vpp of 4.5 kV to the discharge electrode, printed articles 1-10 were conveyed with a speed of 120 mm/min. The creeping discharge electrode 3 and the endless belt 5 were so arranged that the chromium electrode on the bottom face of the dielectric member and the printed article had a distance of 1.0 mm. The printed articles employed in Reference Examples 1 to 10 respectively correspond, in this order, to the printed articles 1 to 10.

### Reference Example 11

In an apparatus shown in FIG. 4 and explained in the foregoing item [3] (2) [discharge electrode (wire): tungsten, counter electrode (conductive endless belt): carbon-containing polycarbonate], under the application of a DC voltage of −1.5 kV to the discharge electrode, a printed article 10 was conveyed with a speed of 10 mm/min.

### Reference Example 12

In an apparatus shown in FIG. 5 and explained in the foregoing item [3] (2) [discharge electrode (wire): tungsten, counter electrode (conductive plate): aluminum], under the application of a DC voltage of −1.5 kV to the discharge electrode, a printed article 10 was conveyed with a speed of 10 mm/min.

### Reference Example 13

In an apparatus shown in FIG. 6 and explained in the foregoing item [3] (1) (dielectric member: alumina ceramics, discharge electrode: aluminum, counter electrode: aluminum), an AC voltage of a frequency of 10 kHz and an applied voltage Vpp of 10 kV was applied to the discharge electrode. A printed article 10 was let to stand for 2 hours in this apparatus.

### Reference Examples 14 to 16

In an apparatus shown in FIG. 7 and explained in the foregoing item [3] (2) [discharge electrode (conductive roll): carbon-containing silicone rubber, counter electrode (conductive drum): carbon-containing silicone rubber], under the application of DC voltages shown in the following Table 4 to the discharge electrode, a printed article 10 was conveyed with a speed of 10 mm/min.

### Reference Example 17

In an apparatus shown in FIG. 8 and explained in the foregoing item [3] (2) [discharge electrode (wire): tungsten, counter electrode (conductive drum): aluminum], under the application of a DC voltage of −1.5 kV to the discharge electrode, a printed article 10 was conveyed with a speed of 10 mm/min.

### Reference Example 18

In an apparatus shown in FIG. 9 and explained in the foregoing item [3] (2) [discharge electrode (conductive roll): carbon-containing silicone rubber, counter electrode (conductive drum): carbon-containing silicone rubber], under the application of a voltage obtained by superposing an AC voltage of a frequency of 1 kHz and an applied voltage of 1.5 kV with a DC voltage of −1.5 kV to the discharge electrode, a printed article 10 was conveyed with a speed of 10 mm/min.

### Examples 1 and 2

In an apparatus shown in FIG. 1 and explained in the foregoing item [3] (1) (dielectric member: alumina ceramics, electrode embedded in the dielectric member: chromium, electrode provided on the bottom face of the dielectric member: chromium), under the application of an AC voltage of a frequency of 5 kHz and an applied voltage Vpp of 4.5 kV to the discharge electrode, printed articles 11 and 12 were conveyed with a speed of 120 mm/min. The creeping discharge electrode 3 and the endless belt 5 were so arranged that the chromium electrode on the bottom face of the dielectric member and the printed article had a distance of 1.0 mm. The printed articles employed in Examples 1 and 2 respectively correspond, in this order, to the printed articles 11 and 12.

### Examples 3 and 4

In an apparatus shown in FIG. 5 and explained in the foregoing item [3] (2) [discharge electrode (wire): tungsten, counter electrode (conductive plate): aluminum], under the application of a DC voltage of −1.5 kV, printed articles 11 and 12 were conveyed with a speed of 10 mm/min. The printed articles employed in Examples 3 and 4 respectively correspond, in this order, to the printed articles 11 and 12.

### Comparative Example 1

The ink 7 was solid printed with an on-demand type ink jet printer (trade name: Wonder BJ F-660, manufactured by Canon Corp.) utilizing a heat generating element as an ink discharging energy source on a Bright Recycled paper (manufactured by Fuji Xerox Co.) to obtain a printed article 13. In an apparatus shown in FIG. 1 and explained in the foregoing item [3] (1) (dielectric member: alumina ceramics, electrode embedded in the dielectric member: chromium, electrode provided on the bottom face of the dielectric member: chromium), under the application of an AC voltage of a frequency of 5 kHz, and an applied voltage Vpp of 4.5 kV to the discharge electrode, the obtained printed article 13 was conveyed with a speed of 120 mm/min.

### Comparative Example 2

The printed article 10 was let to stand for 20 hours at a position (2,000 lux) at a distance of 25 cm below from a daylight color fluorescent lamp.

In each printed article subjected to a discharge process in Reference Examples 1 to 18, Examples 1 to 4, and Comparative Examples 1 and 2, optical densities of the print before and after the discharge process (before and after light irradiation in Comparative Example 2) was measured by a color transmission/reflection densitometer (trade name: X-Rite 310TR, manufactured by X-Rite, Inc.), and the optical density after the discharge process relative to the optical density before the discharge process (optical density retention rate=optical density after discharge process/optical density before discharge process×100) was determined. Results are shown in Tables 4 (1) to 4 (5).

TABLE 4(1)

| | Reference | Reference | Reference | Reference | Reference |
|---|---|---|---|---|---|
| | Example 1 | Example 2 | Example 3 | Example 4 | Example 5 |
| Printed article | | | | | |
| Recording medium | Alumina coat | Alumina coat | Alumina coat | Silica coat | Alumina |
| | paper | paper | paper | paper | coat paper |
| Dye in ink | Tetrasodium | Tetrasodium | Tetrasodium | Tetrasodium | Gardenia |
| | copper | copper | copper | copper | yellow dye |
| | phthalocyanine | phthalocyanine | phthalocyanine | phthalocyanine | |
| | tetrasulfonate | tetrasulfonate | tetrasulfonate | tetrasulfonate | |
| Discharge process | | | | | |
| Apparatus Fig. No. | | | | | |
| Type of discharge | Creeping | Creeping | Creeping | Creeping | Creeping |
| | discharge | discharge | discharge | discharge | discharge |
| Material of creeping discharge | | | | | |
| electrode | | | | | |
| Electrode embedded in dielectric | Chromium | Chromium | Chromium | Chromium | Chromium |
| member | | | | | |
| Electrode under bottom face of | Chromium | Chromium | Chromium | Chromium | Chromium |
| dielectric member | | | | | |
| Type of voltage | AC | AC | AC | AC | AC |
| AC frequency (kHz) | 5 | 5 | 5 | 5 | 5 |
| AC applied voltage (kV) | 4.5 | 4.5 | 4.5 | 4.5 | 4.5 |
| DC applied voltage (kV) | — | — | — | — | — |
| Conveying speed (mm/min) | 120 | 120 | 120 | 120 | 120 |
| Distance between electrode on | 1.0 | 1.0 | 1.0 | 1.0 | 1.0 |
| bottom face of dielectric member | | | | | |
| and printed article (mm) | | | | | |
| Optical density retention rate (%) | 81 | 61 | 62 | 50 | 52 |

TABLE 4(2)

| | Reference | Reference | Reference | Reference | Reference |
|---|---|---|---|---|---|
| | Example 6 | Example 7 | Example 8 | Example 9 | Example 10 |
| Printed article | | | | | |
| Recording medium | Alumina coat | Alumina coat | Alumina | Alumina coat | Alumina coat |
| | paper | paper | coat paper | paper | paper |
| Dye in ink | Cayenne dye | Chlorophyll | Indigocarmine | Monascus | Monascus |
| | | | | yellow dye | yellow dye |
| Discharge process | | | | | |
| Apparatus Fig. No. | | | | | |
| Type of discharge | Creeping | Creeping | Creeping | Creeping | Creeping |
| | discharge | discharge | discharge | discharge | discharge |
| Material of creeping discharge | | | | | |
| electrode | | | | | |
| Electrode embedded in dielectric | Chromium | Chromium | Chromium | Chromium | Chromium |
| member | | | | | |
| Electrode under bottom face of | Chromium | Chromium | Chromium | Chromium | Chromium |
| dielectric member | | | | | |
| Material of corona discharge | | | | | |
| electrode | | | | | |
| Discharge electrode | — | — | — | — | — |
| Counter electrode | — | — | — | — | — |
| Type of voltage | AC | AC | AC | AC | AC |
| AC frequency (kHz) | 5 | 5 | 5 | 5 | 5 |
| AC applied voltage (kV) | 4.5 | 4.5 | 4.5 | 4.5 | 4.5 |
| DC applied voltage (kV) | — | — | — | — | — |
| Conveying speed (mm/min) | 120 | 120 | 120 | 120 | 120 |
| Distance between electrode on | 1.0 | 1.0 | 1.0 | 1.0 | 1.0 |
| bottom face of dielectric member | | | | | |
| and printed article (mm) | | | | | |
| Optical density retention rate (%) | 10 | 44 | 9 | 6 | 8 |

TABLE 4(3)

| | Reference | Reference | Reference | Reference | Reference |
|---|---|---|---|---|---|
| | Example 11 | Example 12 | Example 13 | Example 14 | Example 15 |
| Printed article | | | | | |
| Recording medium | Alumina coat | Alumina coat | Alumina coat | Alumina coat | Alumina coat |
| | paper | paper | paper | paper | paper |
| Dye in ink | Monascus | Monascus | Monascus | Monascus | Monascus |
| | yellow dye | yellow dye | yellow dye | yellow dye | yellow dye |
| Discharge process | | | | | |
| Apparatus Fig. No. | | | | | |
| Type of discharge | Corona | Corona | Creeping | Corona | Corona |
| | discharge | discharge | discharge | discharge | discharge |
| Material of creeping discharge electrode | | | | | |
| Electrode embedded in dielectric member | — | — | — | — | — |
| Electrode under bottom face of | — | — | — | — | — |
| dielectric member | | | | | |
| Material of corona discharge electrode | | | | | |
| Discharge electrode | Tungsten | Tungsten | Aluminum | Carbon- | Carbon- |
| | wire | wire | | containing | containing |
| | | | | silicone | silicone |
| | | | | rubber | rubber |
| Counter electrode | Carbon- | Aluminum | Aluminum | Carbon- | Carbon- |
| | containing | | | containing | containing |
| | polycarbonate | | | silicone | silicone |
| | | | | rubber | rubber |
| Type of voltage | DC | DC | AC | DC | DC/AC |
| AC frequency (kHz) | — | — | 10 | — | 1 |
| AC applied voltage (kV) | — | — | 10 | — | 1.5 |
| DC applied voltage (kV) | −1.5 | −1.5 | — | −1.5 | −0.7 |
| Conveying speed (mm/min) | 10 | 10 | — | 10 | 10 |
| Distance between discharge electrode and | 10 | 10 | 100 | 0 | 0 |
| counter electrode (mm) | | | | | |
| Optical density retention rate (%) | 10 | 10 | 4 | 20 | 10 |

TABLE 4(4)

| | Reference Example 16 | Reference Example 17 | Reference Example 18 |
|---|---|---|---|
| Printed article | | | |
| Recording medium | Alumina coat paper | Alumina coat paper | Alumina coat paper |
| Dye in ink | Monascus yellow dye | Monascus yellow dye | Monascus yellow dye |
| Discharge process | | | |
| Apparatus Fig. No. | | | |
| Type of discharge | Corona discharge | Corona discharge | Corona discharge |
| Material of creeping discharge electrode | | | |
| Electrode embedded in dielectric member | — | — | — |
| Electrode under bottom face of dielectric | — | — | — |
| member | | | |
| Material of corona discharge electrode | | | |
| Discharge electrode | Carbon-containing | Tungsten | Tungsten |
| | silicone rubber | | |
| Counter electrode | Carbon-containing | Aluminum | Aluminum |
| | silicone rubber | | |
| Type of voltage | AC | DC | DC/AC |
| AC frequency (kHz) | 1 | — | 1 |
| AC applied voltage (kV) | 1.5 | — | 1.5 |
| DC applied voltage (kV) | — | −1.5 | −1.5 |
| Conveying speed (mm/min) | 10 | 10 | 10 |
| Distance between discharge electrode and | 0 | 10 | 0 |
| counter electrode (mm) | | | |
| Ultraviolet irradiation process | | | |
| illumination intensity (1x) | — | — | — |
| irradiation time (hrs) | — | — | — |
| Optical density retention rate (%) | 44 | 8 | 10 |

TABLE 4(5)

| | Example 1 | Example 2 | Example 3 | Example 4 |
|---|---|---|---|---|
| Printed article | | | | |
| Recording medium | Alumina coat | Alumina coat | Alumina coat | Alumina coat |
| | paper | paper | paper | paper |
| Dye in ink | Violet dye | Monascus | Violet dye | Monascus yellow |
| | | yellow dye | (PP-V) | dye |
| Discharge process | | | | |
| Apparatus Fig. No. | | | | |
| Type of discharge | Creeping | Creeping | Corona | Corona discharge |
| | discharge | discharge | discharge | |
| Material of creeping discharge electrode | | | | |
| Electrode embedded in dielectric member | Chromium | Chromium | — | — |
| Electrode under bottom face of | Chromium | Chromium | — | — |
| dielectric member | | | | |
| Material of corona discharge electrode | | | | |
| Discharge electrode | — | — | Tungsten wire | Tungsten wire |
| Counter electrode | — | — | Aluminum | Aluminum |
| Type of voltage | AC | AC | DC | DC |
| AC frequency (kHz) | 5 | 5 | — | — |
| AC applied voltage (kV) | 4.5 | 4.5 | — | — |
| DC applied voltage (kV) | — | — | −1.5 | −1.5 |
| Conveying speed (mm/min) | 120 | 120 | 10 | 10 |
| Distance between discharge electrode and | 1.0 | 1.0 | 10 | 10 |
| counter electrode (mm) | | | | |
| Optical density retention rate (%) | 10.0 | 10.0 | 14.3 | 17.0 |

As can be apparent from Table 4, Examples 1 to 4 and Reference Examples 1 to 18, in which printed articles formed with ink jet ink on members applied with inorganic pigments are exposed to an oxidizing gas generated by creeping discharge or corona discharge, show low optical density retention rates and excellent color-erasing/color-density-decreasing property. The color-erasing/color-density-decreasing property is excellent particularly in case of employing a natural dye as the dye, and more excellent in case of employing violet dye (PP-V) or a monascus yellow dye. It is also indicated that, in case of applying a DC voltage in corona discharge, the color-erasing/color-density-decreasing property can be improved by employing a negative polarity. It is also indicated that the color-erasing/color-density-decreasing property is particularly excellent in case of employing alumina as the inorganic pigment of the member applied with the inorganic pigment.

This application claims priority from Japanese Patent Application No. 2004-264385 filed Sep. 10, 2004, which is hereby incorporated by reference herein.

1. An erasable ink comprising:
a solvent; and
at least one dye selected from a violet dye that can be produced by a Penicillium fungus and a yellow dye that can be produced by a Monascus fungus,
wherein a color of the erasable ink is erased by creeping discharge or corona discharge.

2. The erasable ink according to claim 1, wherein the Penicillium fungus comprises Penicillium purpurogenum.

3. An erasable ink comprising:
a solvent; and
an azaphilone-based compound represented by the following general formula (I): 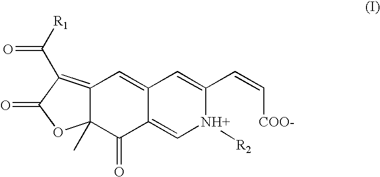
(In the formula, R₁ represents an alkyl group having 2 to 10 carbon atoms, and R₂ represents a hydrogen atom or a group that can be a side chain of a primary amine),
wherein a color of the erasable ink is erasable by creeping discharge or corona discharge.

4. The erasable ink according to claim 3, wherein R₁=C₇H₁₅ and R₂═H in the compound represented by the general formula (I).

5. An erasable ink comprising:
a solvent; and
a Xanthomonasin compound represented by the following general formula (II): 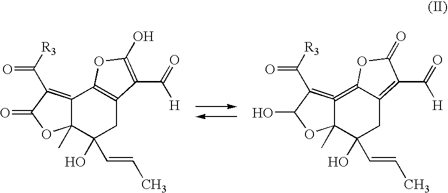
(In the formula, R₃ represents an alkyl group having 2 to 10 carbon atoms),
wherein a color of the erased ink is erasable by creeping discharge or corona discharge.

6. The erasable ink according to claim 5, wherein R₃=C₅H₁₁ or C₇H₁₅ in the compound represented by the general formula (II).

7. A method of erasing an image of a printed article formed on a surface, which contains an inorganic pigment, of a recording medium, the image being formed on the surface by means of the ink according to claim 1, the method comprising the steps of:
(i) applying a voltage between a first electrode and a second electrode separated by a dielectric member having a surface for creeping discharge in an atmosphere of a gas capable of generating an oxidizing gas through discharge to generate creeping discharge from a surface for creeping discharge, to thereby generate an oxidizing gas from the gas; and
(ii) exposing the image of the printed article to the oxidizing gas.

8. A method of erasing an image of a printed article formed on a surface, which contains an inorganic pigment, of a recording medium, the image being formed on the surface by means of the ink according to claim 1, the method comprising the steps of:
(i) applying a voltage which is negative with respect to a grounded first electrode to a second electrode in an atmosphere of a gas capable of generating an oxidizing gas through discharge to generate corona discharge between the electrodes, to thereby generate an oxidizing gas; and
(ii) exposing the image of the printed article to the oxidizing gas.

9. The method of erasing an image according to claim 7, wherein the image comprises an image formed through ink-jet recording by means of an erasable ink comprising:
a solvent; and
at least one dye selected from a violet dye that can be produced by a Penicillium fungus and a yellow dye that can be produced by a Monascus fungus,
wherein a color of the erasable ink is erased by creeping discharge or corona discharge.

10. The method of erasing an image according to claim 8, wherein the image comprises an image formed through ink-jet recording by means of an erasable ink comprising:
a solvent; and
at least one dye selected from a violet dye that can be produced by a Penicillium fungus and a yellow dye that can be produced by a Monascus fungus,
wherein a color of the erasable ink is erased by creeping discharge or corona discharge.

11. A method of recycling a recording medium having, on its surface which contains an inorganic pigment, an image of a printed article formed by means of an erasable ink comprising (a) a solvent, and (b) at least one dye selected from a violet dye that can be produced by a Penicillium fungus and a yellow dye that can be produced by a Monascus fungus, wherein a color of the erasable ink is erased by creeping discharge or corona discharge, the method comprising erasing the image by means of the method according to claim 7.

12. A method of recycling a recording medium having, on its surface which contains an inorganic pigment, an image of a printed article formed by means of an erasable ink comprising (a) a solvent, and (b) at least one dye selected from a violet dye that can be produced by a Penicillium fungus and a yellow dye that can be produced by a Monascus fungus, wherein a color of the erasable ink is erased by creeping discharge or corona discharge, the method comprising erasing the image by means of the method according to claim 8.

13. A method of recycling a recording medium having, on its surface which contains an inorganic pigment, an image of a printed article formed by means of an erasable ink comprising (a) a solvent, and (b) at least one dye selected from a violet dye that can be produced by a Penicillium fungus and a yellow dye that can be produced by a Monascus fungus, wherein a color of the erasable ink is erased by creeping discharge or corona discharge, the method comprising erasing the image by means of the method according to claim 9.

14. A method of recycling a recording medium having, on its surface which contains an inorganic pigment, an image of a printed article formed by means of an erasable ink comprising (a) a solvent, and (b) at least one dye selected from a violet dye that can be produced by a Penicillium fungus and a yellow dye that can be produced by a Monascus fungus, wherein a color of the erasable ink is erased by creeping discharge or corona discharge, the method comprising erasing the image by means of the method according to claim 10.
